(19) United States
(12) Patent Application Publication
(10) Pub. No.: US 2015/0081409 A1
(43) Pub. Date: Mar. 19, 2015

(54) SERVER AND METHOD FOR PROVIDING USER WITH REWARD

(71) Applicant: DeNA Co., Ltd., Tokyo (JP)

(72) Inventors: Mamoru YAMASHIKI, Tokyo (JP); Takatomo OKITSU, Tokyo (JP); Yosaku TOYAMA, Tokyo (JP); Koichi BABAZONO, Tokyo (JP)

(73) Assignee: DeNA Co., Ltd., Tokyo (JP)

(21) Appl. No.: 14/098,277

(22) Filed: Dec. 5, 2013

(30) Foreign Application Priority Data
Sep. 19, 2013 (JP) 2013-193937

(51) Int. Cl. G06Q 30/02

(52) U.S. Cl. CPC G06Q 30/0214
USPC 705/14.16

(57) ABSTRACT

A server according to an embodiment allows a user to more comfortably enjoy communication with other users. This server executes a reward granting program including a user identification module that identifies, in response to a request from a terminal device of one user, one or a plurality of users from among the plurality of users based on present locations of the plurality of users, a user information transmission module that transmits information on the identified users to the terminal device of the one user, a first execution module that receives, from the terminal device of the one user, a request for execution of greeting transmission by the one user on another user selected by the one user from among the identified users and executes the greeting transmission, a second execution module that receives, from a terminal device of the other user, a request for execution of greeting reply to the one user by the other user for whom the greeting transmission is executed and executes the greeting reply, and a reward granting module that grants points to the one user and the other user in accordance with execution of the greeting reply to the one user by the other user.

### CROSS-REFERENCE TO RELATED APPLICATIONS

The present application claims a priority based on Japanese Patent Application No. 2013-193937, filed on Sep. 19, 2013, the disclosure of which is incorporated herein by reference in its entirety.

### FIELD OF THE INVENTION

The present invention relates to a server and a method for granting predetermined rewards to a plurality of users.

### BACKGROUND

Conventionally, services are provided for activating communication between users using a terminal device such as smartphone. As one of such services, a service is also proposed which grants points to users by causing the users to mutually read QR codes (registered trademark) displayed on their respective terminal devices (e.g., Phewtick, [online], searched on Sep. 13, 2013), Internet <see URL, https://play.google.com/store/apps/details?id=com.phewtick&hl=ja>).

However, since the above-described service requires the users to actually meet one another in the actual world to mutually read QR codes displayed in their terminal devices, the users cannot comfortably enjoy communication with more users. On the other hand, since nearby users are likely to be able to perform more intimate communication including the actual world, there are also users who actively participate in communication with such users. Therefore, there is a demand for provision of a mechanism which allows a user to more comfortably enjoy communication with other users including nearby users.

It is one of objects of the present invention to allow a user to more comfortably enjoy communication with other users. Another object of the present invention will be made clear with reference to the entire present specification.

### SUMMARY

A server according to an embodiment of the present invention is a server that grants predetermined rewards to a plurality of users, provided with one or a plurality of processors that execute a predetermined program, the predetermined program including: a user identification module that identifies, in response to a request from a terminal device of a first user, one or a plurality of users from among the plurality of users based on present locations of the plurality of users; a user information transmission module that transmits information on the identified users to the terminal device of the first user; a first execution module that receives a first action execution request by the first user on a second user selected by the first user from among the identified users from the terminal device of the first user and executes the first action; a second execution module that receives a second action execution request on the first user by the second user for whom the first action is executed from a terminal device of the second user and executes the second action; and a reward granting module that grants predetermined rewards to the first user in accordance with execution of the second action on the first user by the second user. The “predetermined rewards” here may include various rewards that can be granted to a user such as points, virtual currency, item, and card. Furthermore, the “first action” and “second action” may include various actions that can be executed among users such as transmission and reply of a greeting, message, icon and stamp. Moreover, the “first action” and “second action” may include a case where they are the same action, a case where they are corresponding actions and a case where they are different actions.

A method according to an embodiment of the present invention is a method for granting predetermined rewards to a plurality of users, including: identifying, in response to a request from a terminal device of a first user, one or a plurality of users from among the plurality of users based on present locations of the plurality of users; transmitting information on the identified users to the terminal device of the first user; receiving a first action execution request by the first user on a second user selected by the first user from among the identified users from the terminal device of the first user and executing the first action; receiving a second action execution request on the first user by the second user for whom the first action is executed from a terminal device of the second user and executing the second action; and granting predetermined rewards to the first user in accordance with execution of the second action on the first user by the second user.

Various embodiments of the present invention allow a user to more comfortably enjoy communication with other users.

### BRIEF DESCRIPTION OF THE DRAWINGS

FIG. 1 is a block diagram schematically illustrating a hardware configuration of a system 1 including a server 10 according to an embodiment of the present invention;

FIG. 2 is a block diagram schematically illustrating a module configuration of a reward granting program 50 according to the embodiment;

FIG. 3 is a diagram illustrating an example of a user information management table according to the embodiment;

FIG. 4 is a diagram illustrating an example of a greeting management table according to the embodiment;

FIG. 5 is a sequence diagram illustrating a situation of communication between the server 10 and the terminal device 30 according to the embodiment;

FIG. 6 is a diagram illustrating an example of a main screen 60 according to the embodiment;

FIG. 7 is a diagram illustrating an example of a map image 70 according to the embodiment;

FIG. 8 is a diagram illustrating an example of a greeting transmission instructing screen 80 according to the embodiment;

FIG. 9 is a diagram illustrating an example of a greeting reception history screen 90 according to the embodiment;

FIG. 10 is a diagram illustrating an example of a greeting reply instructing screen 100 according to the embodiment;

FIG. 11 is a diagram illustrating an example of a game screen 110 according to the embodiment; and

FIG. 12 is a diagram illustrating an example of the greeting reception history screen 90 according to the embodiment.

### DESCRIPTION OF EXAMPLE EMBODIMENTS

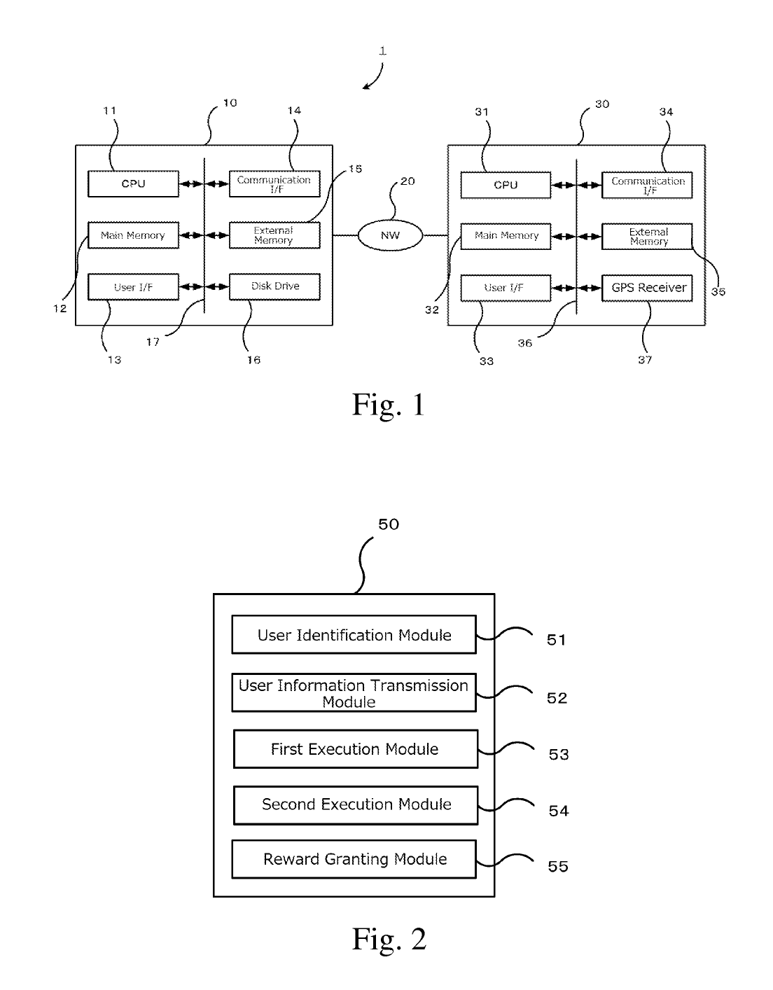

FIG. 1 is a block diagram schematically illustrating a hardware configuration of a system 1 including a server 10 according to an embodiment of the present invention. As shown in FIG. 1, the server 10 according to an embodiment may be communicatively connected via a communication network 20 such as the Internet to a terminal device 30 configured as a conventional computer, and may provide predetermined rewards to a user operating the terminal device 30. Additionally, the server 10 may be communicatively connected to terminal devices other than the terminal device 30 and not shown. The server 10 may provide various Internet services, and provide a platform service that implements various communications between a plurality of users operating a plurality of terminal devices 30.

As shown, the server 10 may include a central processing unit (CPU) (processor) 11, a main memory 12, a user interface (I/F) 13, a communication I/F 14, an external memory 15, and a disk drive 16, and these components may be electrically connected to one another via a bus 17. The CPU 11 may load an operating system and various programs such as control programs for controlling the provision of various services into the main memory 12 from the external memory 15, and may execute commands included in the loaded programs. The main memory 12 may be used to store a program to be executed by the CPU 11, and may be formed of, for example, a dynamic random access memory (DRAM).

The user I/F 13 may include, for example, an information input device such as a keyboard or a mouse for accepting an input from an operator, and an information output device such as a liquid crystal display for outputting calculation results of the CPU 11. The communication I/F 14 may be implemented as hardware, firmware, or communication software such as a transmission control protocol/Internet protocol (TCP/IP) driver or a point-to-point protocol (PPP) driver, or a combination thereof, and may be configured to be able to communicate with the terminal devices 30 via the communication network 20.

The external memory 15 may be formed of, for example, a magnetic disk drive and store various programs such as a control program for controlling the provision of various services. The external memory 15 may also store various data used in providing the various services. The various data that may be stored in the external memory 15 may also be stored on a database server communicatively connected to the server 10 and physically separate from the server 10. The disk drive 16 may read data stored in a storage medium such as a compact disc read only memory (CD-ROM), digital versatile disc read only memory (DVD-ROM), or DVD Recordable (DVD-R) disc, or write data to such a storage medium.

In an embodiment, the server 10 may be a web server for managing a web site including a plurality of hierarchical web pages. The terminal devices 30 may fetch HTML data for rendering a web page from the server 10 and analyze the HTML data to present the web page to a user of the terminal devices 30. The HTML data for rendering the web page may also be stored on the external memory 15. The HTML data may comprise HTML documents written in markup languages such as HTML; the HTML documents may be associated with various images. Additionally, the HTML documents may include programs written in script languages such as ActionScript™ and JavaScript™.

The external memory 15 may store various applications to be executed on execution environments of the terminal device 30 other than browser software. These various applications may include various programs and various data such as image data to be referred to for executing the programs. The programs may be created in, for example, object oriented languages such as Objective-C™ and Java™. The created programs may be stored on the external memory 15 in the form of application software along with various data. The application software stored on the external memory 15 may be delivered to a terminal device 30 in response to a delivery request. The application software delivered from the server 10 may be received by the terminal device 30 through a communication I/F 34 in accordance with the control of CPU 31 and sent to an external memory 35 for storage thereon. The application software may be launched in accordance with the user's operation on the terminal device 30 and may be executed on a platform implemented on the terminal device 30 such as NgCore™ or Android™. The server 10 may provide the applications executed on the terminal devices 30 with various data required for providing various services. Additionally, the server 10 can store various data sent from the terminal device 30 for each user, thereby managing the provision of the various services.

Thus, the server 10 may manage the web site for providing various services and deliver web pages constituting the web site in response to a request from the terminal device 30, thereby providing various services. Also, the server 10 can provide various services based on communication with an application performed on the terminal device 30 in place of, or in addition to, such browser-based services. Whichever mode may be taken to provide the services, the server 10 can store data required to provide the various services for each identification identifying a user. Briefly, the server 10 may also include a function to authenticate a user at start of provision of services and perform charging process in accordance with provision of services. The types of the various services implemented by the web site or applications of the server 10 are not limited to those explicitly described herein.

In an embodiment, the terminal device 30 may be any information processing device that may display on a web browser a web page of a web site obtained from the server 10 and include an application executing environment for executing applications; and the terminal devices 30 may include smartphones, tablet terminals, and game-dedicated terminals.

As shown, the terminal device 30 may include a central processing unit (CPU) (processor) 31, a main memory 32, a user interface (I/F) 33, a communication I/F 34, an external memory 35, and a GPS receiver 37, and these components may be electrically connected to one another via a bus 36.

The CPU 31 may load various programs such as an operating system into the main memory 32 from the external memory 35, and may execute commands included in the loaded programs. The main memory 32 may be used to store a program to be executed by the CPU 31, and may be formed of, for example, a dynamic random access memory (DRAM).

The user I/F 33 may include an information input device for receiving user inputs and an information output device for outputting an operation result of CPU 31; and the user I/F may include a display device such as a liquid crystal display having a touch panel.

The communication I/F 34 may be implemented as hardware, firmware, or communication software such as a transmission control protocol/Internet protocol (TCP/IP) driver or a point-to-point protocol (PPP) driver, or a combination thereof, and may be configured to be able to communicate with the server 10 via the communication network 20.

The external memory 35 may comprise, for example, a magnetic disk drive or a flash memory and store various programs such as an operating system. When receiving an application from a server 10 via the communication I/F 34, the external memory 35 may store the received application.

The GPS receiver 37 may be configured as a general GPS receiver that can receive a radio wave from a GPS satellite (not shown) and acquire position information on a geographic position of the terminal device 30 (GPS receiver 37).

A terminal device 30 having such an architecture may include, for example, browser software for interpreting an HTML file (HTML data) and rendering a screen; this browser software may enable the terminal device 30 to interpret the HTML data fetched from the server 10 and render web pages corresponding to the received HTML data. Further, the terminal device 30 may include plug-in software (e.g., Flash Player distributed by Adobe Systems Incorporated) embedded into browser software; therefore, the terminal device 30 can fetch from the server 10 a SWF file embedded in HTML data and execute the SWF file by using the browser software and the plug-in software. Also, the terminal device 30 can execute an application fetched from the server 10.

Next, the reward granting program 50 to be executed by the CPU 11 of the server 10 according to the embodiment will be described. FIG. 2 is a block diagram illustrating a module configuration of the reward granting program 50 according to the embodiment. The reward granting program 50 may be stored in the external memory 15 or the like, and may be provided with a user identification module 51 that may identify, in response to a request from the terminal device 30 of one user (first user) as illustrated in the drawing, one or a plurality of users from among the plurality of users based on present locations of the plurality of users, a user information transmission module 52 that may transmit information on the identified user to the terminal device 30 of the one user, a first execution module 53 that may receive a request for execution of greeting transmission (first action) by the one user to another user (second user) selected by the one user from among the identified users from the terminal device 30 of the one user and execute greeting transmission, a second execution module 54 that may receive a request for execution of greeting reply (second action) to the one user by the other user for whom the greeting transmission has been executed from the terminal device 30 of the other user and execute the greeting reply, and a reward granting module 55 that may grant points (predetermined rewards) to the one user and the other user in accordance with the execution of the greeting reply to the one user by the other user.

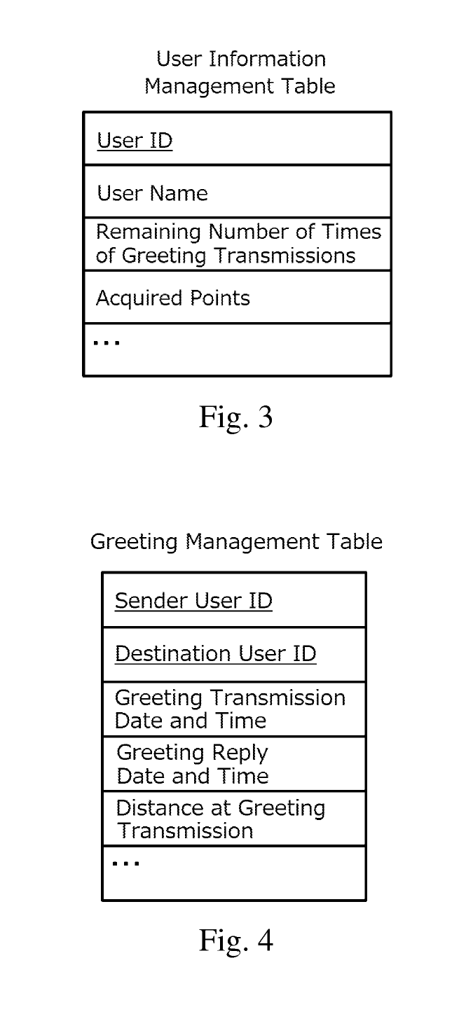

FIG. 3 and FIG. 4 are diagrams illustrating examples of information managed in a user information management table and a greeting management table configured in the external memory 15 of the server 10 or the like. As shown in FIG. 3, the user information management table according to the embodiment may manage information such as a “user name” that identifies a user in association with a “user ID” that identifies the user, the “remaining number of times of greetings transmissions” indicating the remaining number of times the user can execute greeting transmission, and the “acquired points” indicating the total number of points acquired by the user. In the embodiment, a predetermined value (e.g., 5) may be set as an initial value of the “remaining number of times of greetings transmissions” in the user information management table, the number may be designed to be decremented by “1” every time greeting transmission is executed and then recovered by “1” when a predetermined time elapses (e.g., 1 hour). That is, the present embodiment may allow the user to execute greeting transmission within a range of the upper limit number of times one user can execute greeting transmission within a predetermined time, and more specifically, the upper limit number of times greeting transmission can be executed within N hours may be assumed to be an “initial value+(N−1).” As a result, it may be possible, for example, to prevent execution of abnormally frequent greeting transmissions by the user.

As shown in FIG. 4, the greeting management table according to the embodiment may manage information such as “greeting transmission date and time” that indicates a date and time at which greeting transmission is executed in association with a combination of a “sender user ID” that identifies a sender user who executes greeting transmission and a “destination user ID” that identifies a destination user for whom the greeting transmission is executed, “greeting reply date and time” that indicates a date and time at which at which greeting reply is executed in response to this greeting transmission and “distance at greeting transmission” that indicates a distance between the sender user and the destination user when greeting transmission is executed.

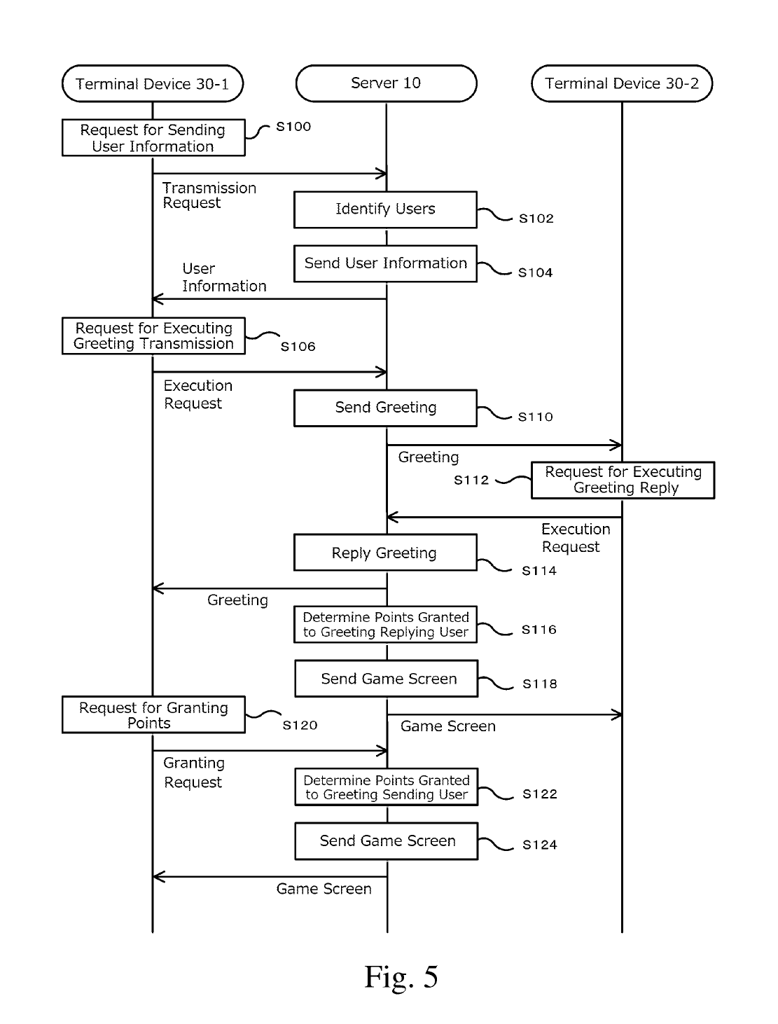

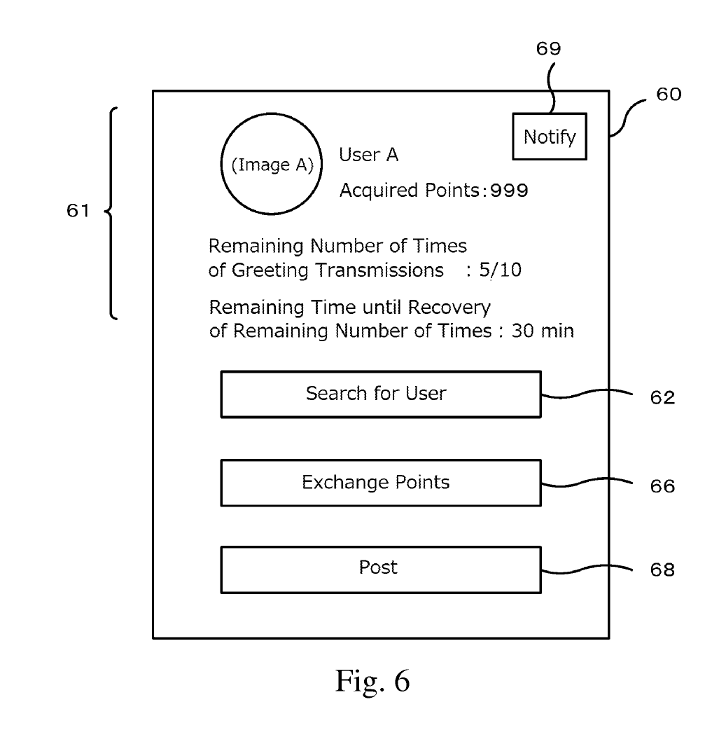

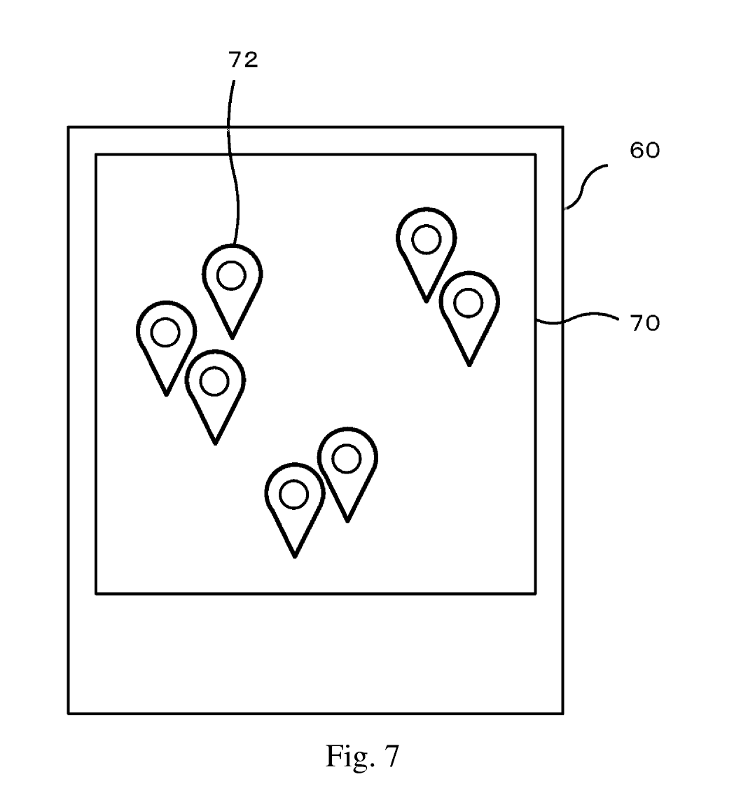

Next, operation of the server 10 according to the embodiment configured as described above will be described. The server 10 of the present embodiment may provide a greeting communication service of granting points to a user in accordance with communication such as greeting transmission and greeting reply between users. FIG. 5 is a sequence diagram illustrating a situation of communication between the server 10 and the terminal devices 30 (terminal devices 30-1 and 30-2) when providing a greeting communication service according to the present embodiment. In this example, the user who operates the terminal device 30-1 is a sender user who executes greeting transmission and the user who operates the terminal device 30-2 is a destination user for whom the greeting transmission is executed and who executes greeting reply in response thereto. When providing a greeting communication service, as illustrated, the terminal device 30-1 may request the server 10 to send user information related to the user who becomes a destination user candidate for whom greeting transmission is executed first (step S100). Here, for convenience of description, a main screen 60 will be described which is a basic screen for a user to receive a provision of a greeting communication service. FIG. 6 shows an example of the main screen 60 according to the present embodiment. As illustrated in the drawing, the main screen 60 may include a user basic information display region 61 for illustrating basic information on the user in an upper part of the screen, may arrange a user search button 62 for searching a destination user who executes greeting transmission below this user basic information display region 61, a point exchange button 66 for exchanging acquired points with cash or an item, a posting button 68 for posting a comment or the like, and may arrange a notification button 69 for displaying a notification content for the user at a top right corner of the screen. The user basic information displayed in the user basic information display region 61 may include, as illustrated in the drawing, information such as an image corresponding to the user, user name, the number of points acquired by the user, the remaining number of times the user can perform greeting transmission, and the remaining time until the remaining number of times is recovered once. Such user basic information may be managed in the aforementioned user information management table. For example, when the user who operates the terminal device 30-1 selects the user search button 62 of the main screen 60, the terminal device 30-1 may request the server 10 to send user information. Note that a user information transmission request can also be made at various timings other than this timing.

When the terminal device 30-1 makes a user information transmission request, the server 10 may identify one or a plurality of users who become destination user candidates who execute greeting transmission based on a present location of each user (step S102). More specifically, in the embodiment, other users may be identified who are located within a predetermined geographic range (e.g., within 5 km) from the present location of the user who operates the terminal device 30-1 based on the present location of each user. The present location of each user can be managed by periodically acquiring position information acquired by the GPS receiver 37 of the terminal device 30 or the like from the terminal device 30 and storing the acquired position information as a present location per user operating the terminal device 30. Such a present location of each user may be managed by the server 10 (e.g., user information management table) or may also be managed by another server or the like with which the server 10 can communicate.

Next, the server 10 may transmit the identified user information on the user to the terminal device 30-1 (step S104). More specifically, a map image with user elements such as an icon image or text corresponding to the user arranged at a position corresponding to the present location of the identified user may be transmitted to the terminal device 30-1. FIG. 7 is an example of a map image 70 displayed on the terminal device 30-1. As shown in the drawing, the map image 70 may be displayed superimposed on the main screen 60 and a user element 72 corresponding to each user may be arranged at a position corresponding to the present location of each identified user on the map image 70. Note that instead of or in addition to this map image 70, user information on the identified user may be displayed in a list form or sequentially displayed in a slideshow form. In this case, a user located at a shorter distance from the user who operates the terminal device 30-1 may be displayed with higher priority (e.g., displayed on a higher row in the list or displayed in an early stage of a slideshow). Furthermore, when the user information on the identified user is displayed on the terminal device 30-1 via the map image 70 or the like, user information on the user who is currently logged in may be displayed with high priority as well.

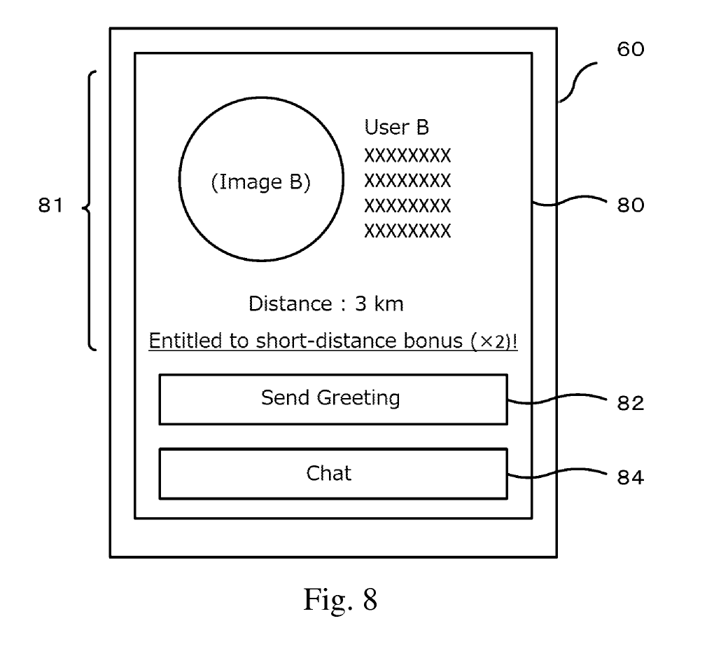

When the user who operates the terminal device 30-1 selects one of the user elements 72 arranged on the map image 70, a greeting transmission instructing screen 80 illustrated in FIG. 8 which can instruct execution of greeting transmission on the user corresponding to the selected user element 72 may be displayed superimposed on the main screen 60. As illustrated in the drawing, the greeting transmission instructing screen 80 may include a user basic information display region 81 indicating basic information on the selected user in an upper part of the screen, and a greeting transmission button 82 for executing greeting transmission on this user and a chat button 84 for chatting with this user may be arranged below this user basic information display region 81. Thus, the greeting transmission instructing screen 80 may be enabled to selectively execute simple communication of greeting transmission or more intimate communication of chat. As the user basic information displayed on the user basic information display region 81, for example, an image or user name corresponding to the user may be included and further the distance between the user who operates the terminal device 30-1 and this user may be included. Here, in the present embodiment, points granted when the distance between the users falls within a predetermined range (e.g., within 3 km) may be set so as to be advantageous to the user (e.g., points become double compared to a case where the distance between the users falls outside the predetermined range), and the user basic information display region 81 may display text indicating that the granted points will be advantageous (“Entitled to short-distance bonus (×2)!” in the example shown in FIG. 8). Moreover, when the remaining number of times of greetings transmissions for the user who operates the terminal device 30-1 is “0,” the greeting transmission button 82 may be prevented from being selected.

Next, when the user who operates the terminal device 30-1 selects the greeting transmission button 82 of the greeting transmission instructing screen 80, a request for execution of greeting transmission may be made from the terminal device 30-1 to the server 10 (step S106), and the server 10 may execute greeting transmission (step S110). The execution of greeting transmission is performed by updating the greeting management table, and more specifically, a user ID of the user who operates the terminal device 30-1 may be set in “sender user ID,” a user ID of the user for whom greeting transmission is executed (user who operates the terminal device 30-2 in this example) may be set in “destination user ID,” a date and time at which greeting transmission is executed may be set in “greeting transmission date and time” and a distance between the users may be set in “distance at greeting transmission.” In addition to an update of the greeting management table, transmission of a message indicating that greeting transmission has been executed may be performed (push indication) on the terminal device 30-2 of the destination user.

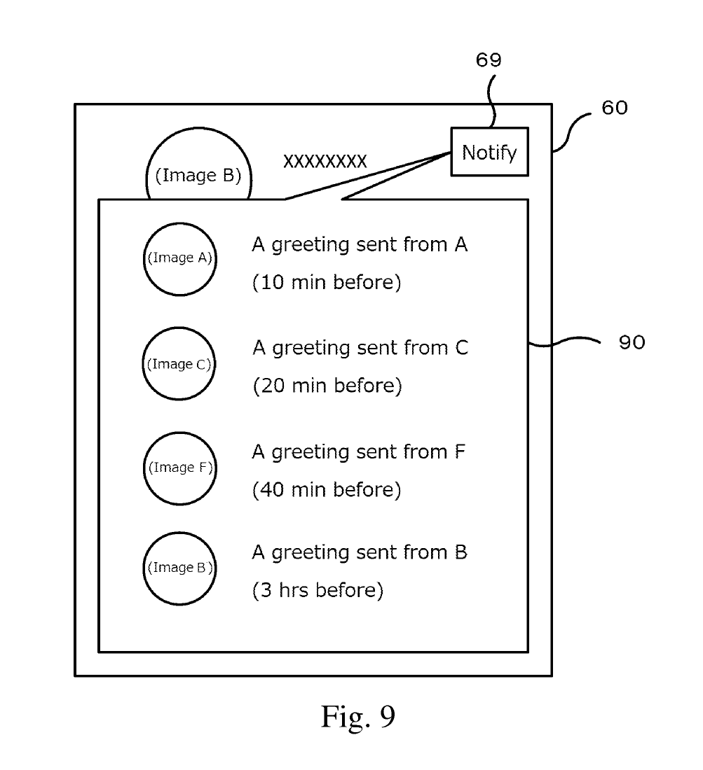

When the greeting transmission is executed and the greeting management table is updated, in the terminal device 30-2 of the destination user for whom greeting transmission is executed, the notification button 69 of the main screen 60 displays information indicating that greeting transmission has been newly executed (e.g., the icon image of the notification button 69 may be changed or displayed in blinking mode), and selecting this notification button 69 may cause a greeting reception history screen 90 shown in FIG. 9 to be displayed. As illustrated in the drawing, the greeting reception history screen 90 shows a reception history of greeting transmissions executed for the user who operates the terminal device 30-2 in a list form. As illustrated in the drawing, each reception history displayed in a list form may include an image of a sender user of greeting transmission and information on the date and time at which the greeting transmission is executed (e.g., date and time themselves or elapsed time after the greeting transmission is executed). When the reception history of greeting transmissions is listed, the list may be sorted in descending or ascending order of dates and times of execution of greeting transmissions. Note that when greeting reply in response to greeting transmission has been received, the reception history displayed in the list on the greeting reception history screen 90 may also include a reception history of the greeting reply as will be described later.

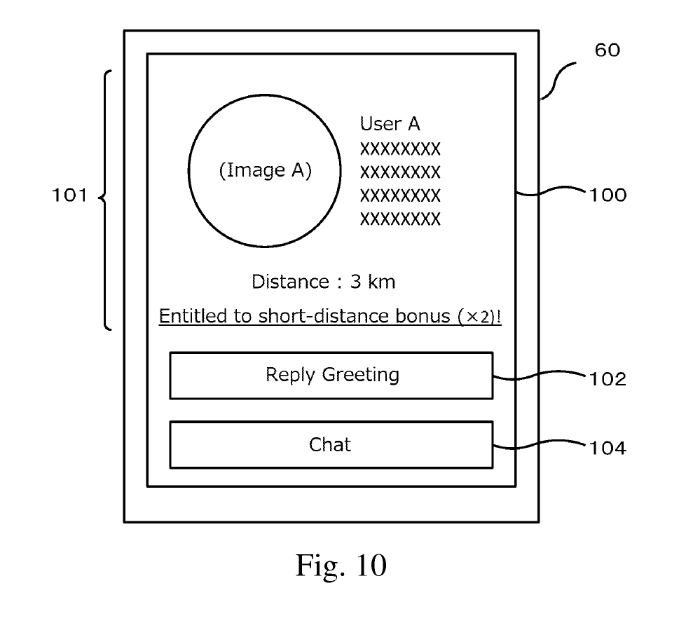

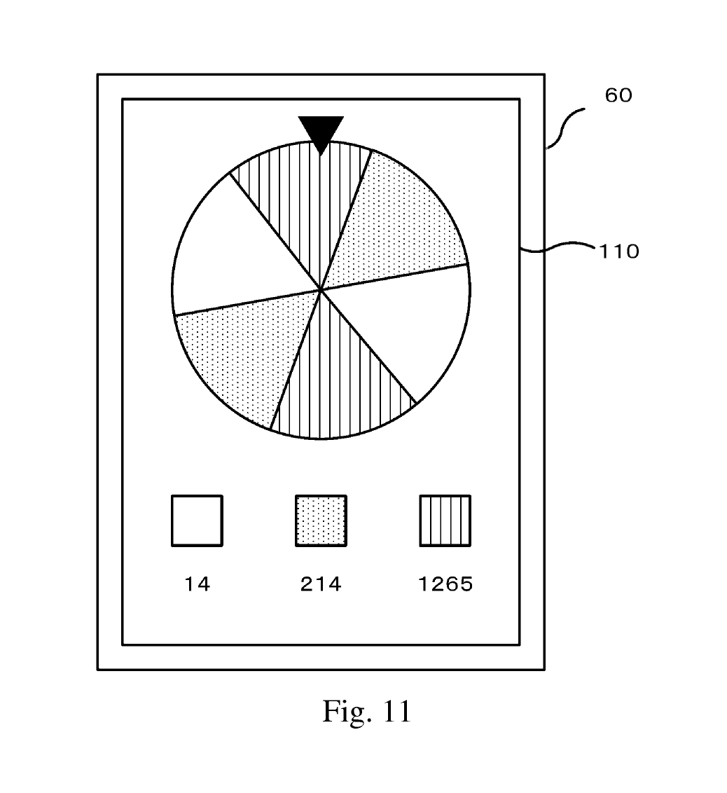

When the user who operates the terminal device 30-2 selects one out of the reception history of greeting transmissions listed on the greeting reception history screen 90, a greeting reply instructing screen 100 illustrated in FIG. 10 may be displayed superimposed on the main screen 60. As illustrated in the drawing, the greeting reply instructing screen 100 may include a user basic information display region 101 that displays basic information of a user corresponding to the selected reception history in an upper part of the screen (sender user of greeting transmission), and greeting reply button 102 for executing greeting reply to the user and a chat button 104 for chatting with the user may be arranged below the user basic information display region 101. Thus, the greeting reply instructing screen 100 may be designed to be able to selectively execute simple communication of greeting reply or intimate communication of chat as in the case of the greeting transmission instructing screen 80. The user basic information displayed in the user basic information display region 101 may include, for example, an image or user name corresponding to the user as in the case of the user basic information display region 81 of the aforementioned greeting transmission instructing screen 80 as illustrated in the drawing, and may further include a distance between the user who operates the terminal device 30-2 and this user (distance when the sender user executes greeting transmission). Note that in the embodiment, greeting transmission may be designed to be executable within an upper limit number of times one user can execute greeting transmission within a predetermined time as described above, but greeting reply can be executed every time greeting transmission is received and the number of times greeting reply is executed is not limited.

Here, in the embodiment, greeting reply is supposed to become executable after a lapse of a predetermined time (e.g., within one hour) since greeting transmission has been executed (in other words, greeting reply needs to be executed within a predetermined time since greeting transmission has been executed). Therefore, regarding a reception history on the aforementioned greeting reception history screen 90 in which an elapsed time after execution of greeting transmission exceeds a predetermined time, the excess of time may be displayed or the user may be prevented from selecting the reception history or the reception history may be hidden or when such a reception history is selected and the greeting reply instructing screen 100 is displayed, the user may be notified of the fact that greeting reply cannot be executed on the greeting reply instructing screen 100 because the elapsed time exceeds a predetermined time since the greeting transmission has been executed.

When the user who operates the terminal device 30-2 selects the greeting reply button 102 of the greeting reply instructing screen 100, the terminal device 30-2 may request the server 10 to execute greeting reply (step S112) and the server 10 may execute greeting reply (step S114). Greeting reply may be executed by updating the greeting management table, and more specifically, the date and time at which greeting reply has been executed may be set in “greeting reply date and time” of the corresponding record. Note that as in the case of execution of greeting transmission in aforementioned step S110, transmission of a message indicating that greeting reply has been executed may be performed (push notification) on the terminal device 30-1 of the user for whom greeting reply has been executed in addition to the update of the greeting management table.

Next, the server 10 may determine the number of points (content of predetermined rewards) to be granted to the user who has executed the greeting reply (step S116). The number of points may be determined by applying various rules. For example, the number of points may be randomly determined using an arithmetic expression using, as a variable, a pseudo-random number generated using a publicly known algorithm. As described above, according to the embodiment, points granted when the distance between users falls within a predetermined range may be set so as to be advantageous to the user, and when the number of points is determined, the number of points corresponding to the distance between users may be determined with reference to the “distance at the time of greeting transmission” of the greeting management table. For example, such an arithmetic expression may be applied that the number of points is doubled when the distance between users falls within a predetermined range or that the smaller the distance between users (the nearer the present locations of users), the greater the number of points becomes. In addition, the number of points may also be determined using a parameter other than the distance between users, and such an arithmetic expression may be applied that the number of points is doubled when an elapsed time after greeting transmission is executed until greeting reply is executed (which can be calculated using the “greeting transmission date and time” and the “greeting reply date and time” in the greeting management table) falls within a predetermined range or that the shorter the elapsed time, the greater the number of points becomes.

Once the number of points to be granted to the user who has executed the greeting reply is determined, the server 10 may transmit a game screen to the terminal device 30-2 (step S118). FIG. 11 shows an example of a game screen 110 displayed superimposed on the main screen 60 in the terminal device 30-2. The embodiment may apply a roulette game screen as the game screen 110 as illustrated in the drawing and the number of points corresponding to a winning pattern of this roulette game (one of “14,” “214” and “1265” in the example in FIG. 11) may correspond to the number of points granted to the user. As described above, in the embodiment, since the number of points granted to the user is predetermined in step S116, this game screen 110 may be set beforehand so as to yield a result conforming to the determined number of points. That is, in the embodiment, the predetermined number of points may be indicated to the user as the game result on the game screen 110. By so doing, the user can better enjoy acquiring points compared to the case where the number of points is simply notified. Note that instead of determining the number of points to be granted before transmitting the game screen, the number of points to be granted may be determined in accordance with the game result on this game screen after transmitting the game screen. In this case, the user may be allowed to operate timing of stopping the roulette, the torque of the roulette or the like. When the game screen 110 is transmitted to the terminal device 30-2 and the game result is displayed in this way, granting of points to the user may be confirmed and the corresponding number of points may be added to the “acquired number of points” in the user information management table.

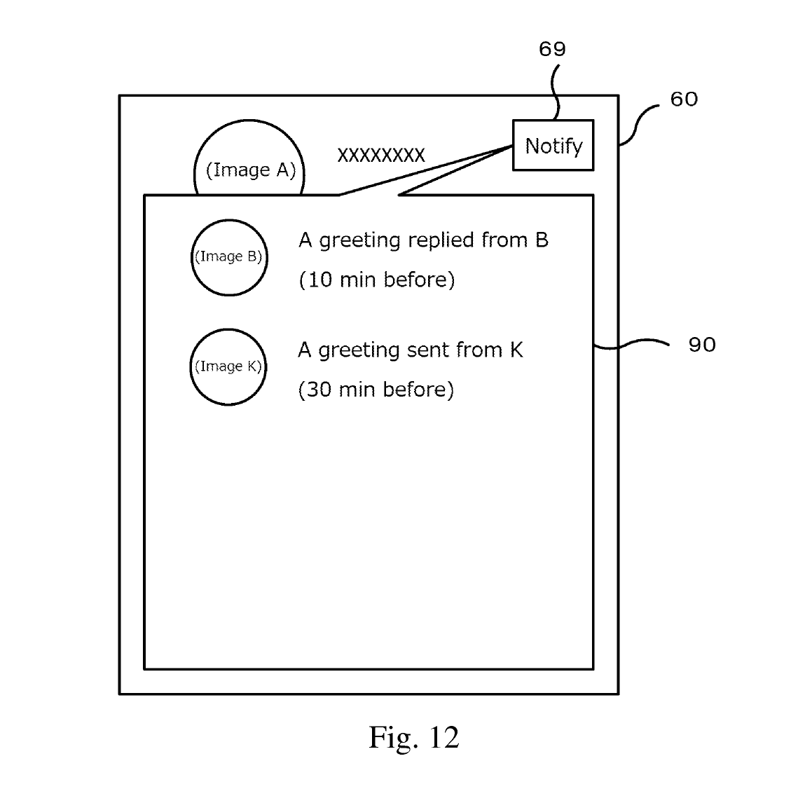

On the other hand, in step S114 when greeting reply is executed and the greeting management table is updated, the notification button 69 of the main screen 60 in the terminal device 30-1 may indicate that greeting reply has been executed as in the case where greeting transmission is executed (e.g., the icon image of the notification button 69 is changed or shown in blinking mode), a greeting reception history screen 90 shown in FIG. 12 may be displayed by selecting the notification button 69. As illustrated in the drawing, when greeting reply is executed, a list of the greeting reception history screen 90 may include a greeting reply reception history. When the user who operates the terminal device 30-1 selects the greeting reply reception history from the reception history displayed in a list form on the greeting reception history screen 90, the terminal device 30-1 may request the server 10 to grant points (step S120). Upon receipt of the point granting request from the terminal device 30-1, the server 10 may determine the number of points to be granted to the user for whom greeting reply has been executed (sender user of greeting transmission) (step S122), and also transmit a game screen for notifying the user of the determined number of points to the terminal device 30-1 (step S124). The determination of the number of points and the transmission of the game screen may be similar to the processing on the aforementioned user who operates the terminal device 30-2 (steps S116 and S118), and therefore further detailed description thereof will be omitted.

Thus, the greeting communication service provided by the server 10 may determine the number of points and grant points to each user in accordance with communication of greeting transmission and greeting reply between users. Points acquired by each user can be exchanged with cash or items (including virtual items usable in various services provided by the server 10) in accordance with the number of points as described above. More specifically, for example, the user can exchange the acquired points with cash or items or the like via a screen that transitions by selecting the point exchange button 66 of the main screen 60. Note that in the aforementioned example, the number of points to be granted to a user who has executed greeting transmission (user who operates the terminal device 30-1) and the number of points to be granted to a user who has executed greeting reply (user who operates the terminal device 30-2) may be determined separately, but the same number of points may also be granted. Furthermore, for example, a number of points determined for each user may also be granted to the other user. That is, when points are granted to a user who has executed greeting reply in steps S116 and S118, and points may be then granted to a user who has executed greeting transmission in steps S122 and S124, the same number of points granted to the user who has executed the greeting reply may also be granted to the user who has executed the greeting transmission, and then at appropriate timing, the same number of points granted to the user who has executed the greeting transmission may also be granted to the user who has executed the greeting reply. By so doing, it may be possible to establish a mechanism whereby the numbers of points respectively determined for the user who has executed the greeting transmission and the user who has executed greeting reply influence each other, and thereby further activate communication between the users. It may be also possible to introduce a mechanism whereby users compete each other for the numbers of points determined for the respective users through a simple competition game or the like.

In response to a request from the terminal device 30-1 of one user (first user), the server 10 according to the embodiment described so far may transmit information on one or a plurality of users identified from a plurality of users to the terminal device 30-1, receive a request to execute greeting transmission (first action) by one user to another user (second user) selected by one user from among the identified users from the terminal device 30-1 of the one user, executes greeting transmission, receive a request to execute greeting reply (second action) by the other user to the one user for whom greeting transmission has been executed from the terminal device 30-2 of the other user, execute greeting reply, and grant points (predetermined rewards) to the one user and the other user in accordance with execution of the greeting reply by the other user to the one user. Therefore, since points are granted to the users in accordance with communication of greeting transmission and greeting reply executed between the users, the user can more comfortably enjoy communication with other users. Moreover, since one or a plurality of users who become destination user candidates who execute greeting transmission are identified based on present locations of the respective users, the user can enjoy communication with more appropriate users based on present locations.

In the embodiment, points may be granted to the one user and the other user in accordance with execution of greeting reply by the other user to the one user, but points may also be granted only to the one user (that is, user who has executed greeting transmission).

In the embodiment, although points have been illustrated as “predetermined rewards” granted to users, points may not be limited to this, and points may be various rewards that can be granted to users, such as virtual currency, item, and card.

In the embodiment, although greeting transmission and greeting reply have been illustrated as action (communication) carried out between users, action may not be limited to this, and various actions such as transmission and reply of a message, icon, and stamp or the like may be considered. Aspects such as greeting transmission and corresponding greeting reply need not necessarily be adopted, and, for example, predetermined rewards such as points may also be granted to each user in accordance with greeting transmission mutually executed between users.

The processes and procedures described and illustrated herein may also be implemented by software, hardware, or any combination thereof other than those explicitly stated for the embodiments. More specifically, the processes and procedures described and illustrated herein may be implemented by the installation of the logic corresponding to the processes into a medium such as an integrated circuit, a volatile memory, a non-volatile memory, a magnetic disk, or an optical storage. The processes and procedures described and illustrated herein may also be installed in the form of a computer program, and executed by various computers.

Even if the processes and the procedures described herein are executed by a single apparatus, software piece, component, or module, such processes and procedures may also be executed by a plurality of apparatuses, software pieces, components, and/or modules. Even if the data, tables, or databases described herein are stored in a single memory, such data, tables, or databases may also be dispersed and stored in a plurality of memories included in a single apparatus or in a plurality of memories dispersed and arranged in a plurality of apparatuses. The elements of the software and the hardware described herein can be integrated into fewer constituent elements or can be decomposed into more constituent elements.

With respect to the use of substantially any plural and/or singular terms herein, those having skill in the art can translate from the plural to the singular and/or from the singular to the plural as is appropriate to the context.

1. A server for facilitating communication for a plurality of users electronically, the server comprising:
a central processing unit configured to execute computer programs; and
memory storage configured to store machine-readable instructions that, when executed, cause the central processing unit to facilitate electronic communication for the plurality of users through the server, facilitating the electronic communication including,
identifying, in response to a request from a terminal device of a first user, one or more of the plurality of users based on present locations of the plurality of users;
transmitting information on the identified users to the terminal device of the first user;
receiving, from the terminal device of the first user, a first request and in response to the first request being received, causing a first action to be executed on the server and presented on a terminal device of a second user selected by the first user from the identified users;
receiving, from the terminal device of the second user, a second request and in response to the second request being received, causing a second action to be executed on the server and presented on the terminal device of the first user, wherein the second request is sent by the terminal device of the second user in response to the first action having been executed; and
granting predetermined rewards to the first user in accordance with the execution of the second action on the server, wherein granting the predetermined rewards to the first user comprises determining contents of the predetermined rewards to be granted to the first user based on a distance in the real-world between the first user and the second user when the first action is executed on the server.

2. The server according to claim 1, wherein facilitating the electronic communication further comprises granting the predetermined rewards to the second user in addition to the first user in accordance with the execution of the second action.

3. The server according to claim 2, wherein granting the predetermined rewards to the first user includes determining a first content of the predetermined rewards for the first user and granting the predetermined rewards to the second user includes determining a second content of the predetermined rewards for the second user.

4. The server according to claim 3, wherein granting the predetermined rewards to the first user further includes granting the second content in addition to the first content of the predetermined rewards to the first user and granting the predetermined rewards to the second user further includes granting the first content in addition to the second content of the predetermined rewards to the second user.

5. The server according to claim 1, wherein granting the predetermined rewards to the first user further includes transmitting screen data of a predetermined game to the terminal device of the first user, determining a content of the predetermined rewards so as to conform to a result of the predetermined game, and granting the rewards to the first user.

6. The server according to claim 1, wherein the one or a plurality of users are identified based on present locations of the plurality of users such that a user at a smaller distance to the first user is higher in priority.

7. The server according to claim 1, wherein the transmitted information includes information on distances from the first user as information on the identified users.

8. The server according to claim 7, wherein the transmitted information includes a map image having elements corresponding to the identified users arranged at positions corresponding to the present locations of the identified users.

9. The server according to claim 1, wherein the content of the predetermined rewards is determined based on an elapsed time after execution of the first action by the first user on the second user until execution of the second action by the second user on the first user.

10. The server according to claim 9, wherein the content of the predetermined rewards is determined such that, as the elapsed time is shorter, the content of the predetermined rewards is more advantageous to the first user.

11. (canceled)

12. The server according to claim 11 1, wherein the content of the predetermined rewards is determined such that, as the distance is smaller, the content of the predetermined rewards is more advantageous to the first user.

13. The server according to claim 1, wherein the first action can be executed for not more than a maximum number of times executable to one user within a predetermined amount of time, and
the second action can be executed every time the first action is executed.

14. A method for facilitating communication for a plurality of users electronically, the method being implemented in a central processing unit configured by machine-readable instructions, the method comprising:
identifying, in response to a request from a terminal device of a first user, one or more of the plurality of users based on present locations of the plurality of users;
transmitting information on the identified users to the terminal device of the first user;
receiving, from the terminal device of the first user, a first request and in response to the first request being received, causing a first action to be executed on the server and presented on a terminal device of a second user selected by the first user from the identified users;
receiving, from the terminal device of the second user, a second request and in response to the second request being received, causing a second action to be executed on the server and presented on the terminal device of the first user, wherein the second request is sent by the terminal device of the second user in response to the first action having been executed; and
granting predetermined rewards to the first user in accordance with the execution of the second action on the server, wherein granting the predetermined rewards to the first user comprises determining contents of the predetermined rewards to be granted to the first user based on a distance in the real-world between the first user and the second user when the first action is executed on the server.
